(19) United States
(12) Patent Application Publication
(10) Pub. No.: US 2011/0079555 A1
(43) Pub. Date: Apr. 7, 2011

(54) Aquarium Filter

(75) Inventor: Tony Chin Huei Wu, San Gabriel, CA (US)

(73) Assignee: AQUATICA GALLERY LLC, Santa Fe Springs, CA (US)

(21) Appl. No.: 12/574,278

(22) Filed: Oct. 6, 2009

(51) Int. Cl. A01K 63/04; C02F 3/00

(52) U.S. Cl. 210/618; 210/167.22

(57) ABSTRACT

An aquarium filtration and drainage system comprising an undergravel filter with a compartment containing biomedia which is positioned over a drain at the bottom of the aquarium.

### BACKGROUND

Filters have been used in aquariums for many years to remove particulate matter and other waste from aquarium water in order to keep aquariums clean. A good and efficient filter is usually equipped with three kinds of filtration features, namely mechanical, chemical, and biological filtration. Each feature removes certain types of debris and impurities in an aquarium and together will achieve a healthy and clean ecosystem in an aquarium.

There are four general types of filters, each of which has distinct function in cleaning specific type of impurities in aquarium water. Traditionally, the most common type of aquarium filter is the open-top external power filter which hangs outside an aquarium over the top edge. It includes a siphon tube which carries water from the aquarium into a filter box located outside the tank. Water entering the filter box flows over various types of filter media to remove particulate matter and chemical impurities from the water, after which the water is cycled back into the aquarium.

Another type of aquarium filter is a large, sealed, and enclosed canister type filter which is placed outside and usually below the aquarium. Intake and output hoses hang over the aquarium edge and are connected to the canister filter on the floor, and water is fed through the intake hose from the aquarium to the canister. The aquarium water is treated and then cycled back into the aquarium by a pump contained in the canister.

An internally mounted power filter is another type of aquarium filter. Such filters comprise a small canister with a built-in pump which is submerged inside the aquarium. Water enters the flow gaps of the canister and flows through filter sleeves with compartments filled with filtration materials to remove particulate and chemical waste. The filtered water is cycled and pumped out from the top of the canister through a power pump and back into the aquarium.

A further type of filter employed in aquariums is the internal undergravel filter, which generally consists of a perforated raised plate resting on the aquarium floor and covered with gravel. Riser tubes are provided on either end of the filter and extend to the top of the aquarium. Air lines from an external pump are placed in the riser tubes and an air stone is placed at the end of the air lines, so that air bubbles leaving from the air stone travel up through the tubes to the water surface and create turbulence or a current in order to pull water through the gravel and up the riser tubes. Alternatively, a pump may be placed on top of the riser tube to force water into, or pull water from, the tube. Waste from the aquarium is drawn through the gravel bed, where beneficial bacteria break down ammonia or nitrites into less harmful nitrates.

Current undergravel filters are usually designed to perform the task of biological filtration and work by drawing debris and impurities into a gravel bed, which is colonized by beneficial bacteria that break down certain aquarium waste such as ammonia. Ammonia is created by water debris, waste deposits and unfinished food and is toxic to fish at high levels. However, for certain types of aquariums, due to limitations in aquarium space and/or in the amount of gravel present, such beneficial bacteria may not be able to grow in sufficient numbers to remove enough ammonia from the water, thus posing a risk to fish living in the aquarium. In addition, as undergravel systems age, debris can build up in the gravel and clog up the filter plate, causing the waste-clearing function of such systems drops off.

Biomedia is sometimes used in external filters in order to increase the amount of bacteria in an aquarium system and thereby break down more waste products. Biomedia is often formed from porous materials, which can become clogged up. As a result, beneficial bacteria in such biomedia can cease to function in breaking down aquarium waste products. The accumulation of debris in an undergravel filter can similarly greatly affect the water quality in an aquarium and cause the level of ammonia to increase to harmful levels. Due to the clogging of undergravel filters, and in order to maintain their biological filtration function, frequent cleanings to keep such filters operative are required.

### SUMMARY

The present invention relates to a drainage and filtration system for an aquarium. In this system, an aquarium is used which includes a drain having drain opening in a bottom surface of the aquarium. The drain further comprises a valve for reversibly opening the drain to allow a flow of water therethrough. This system further includes an undergravel filter positioned over the drain opening that comprises the following components:
(a) a first housing having a lower surface with one or more lower housing openings;
(b) an upper surface opposite the lower surface;
(c) one or more walls extending between the lower surface and the upper surface of the first housing;
(d) one or more upper housing openings in the upper surface of the first housing, the one or more walls, or both; and
(e) a compartment within the first housing containing one or more pieces of biomedia, the compartment being in communication with an exterior of the first housing through the upper housing openings and being in communication with the drain opening through the lower housing openings, thereby allowing a flow of water from the exterior of the first housing through the compartment to the drain when the drain opening is open.

The first housing preferably comprises a debris collecting tray having an upper surface and a lower surface, a cover plate covering the upper surface of the debris collecting tray and comprising the upper surface of the first housing, and a lower plate below the debris collecting tray comprising the lower surface of the first housing. The cover plate is also preferably reversibly secured to the debris collecting tray in order to allow biomedia to be accessed in the debris collecting tray.

The drain of the present system can comprise a collector channel on the bottom surface of the aquarium extending longitudinally between the drain opening and a lateral side of the aquarium. Preferably, the undergravel filter covers more than 50% of the bottom surface of the aquarium, and more preferably covers more than 80% of the bottom surface of the aquarium.

The system can further include a water pump connected to a side wall of the first housing of the undergravel filter, the water pump comprising openings in a lower end in direct communication with upper housing openings in the side wall of the first housing. In a preferred embodiment, the housing can comprises a proximal end and a distal end, the distal end comprising a first half of a mated connector, so that a second housing having the second half of the mated connector, where the mated connector portions cooperate to attach the first housing to the second housing.

The biomedia used in the present system is preferably porous and has a surface-area-to-volume ratio of at least 100 m²/m³. More preferably, the biomedia has a surface-area-to-volume ratio of at least 500 m²/m³. In preferred embodiments, the biomedia material also has an effective surface area of between 20 and 200 square meters/liter of the biomedia material.

In a further aspect, the present invention includes a method of cleaning biomedia in an aquarium. In this method, an aquarium as described above is provided, and when cleaning of the biomedia is desired, the drain opening is opened in order to provide a flow of water through the compartment of the undergravel filter.

### DRAWINGS

FIG. 1 is a front perspective view of an aquarium including the present undergravel filter.

FIG. 2 is an exploded perspective view of an embodiment of the present undergravel filter over an aquarium drain showing the components of the filter.

FIG. 3 is a perspective view of an assembled embodiment of the present undergravel filter.

FIG. 4 is a sectional, front perspective view of the distal side of the undergravel filter of FIG. 3 along line 3-3.

FIG. 5 is an exploded view of the present undergravel filter and a pump.

FIG. 6 is an exploded perspective view of an embodiment of the present undergravel filter over an aquarium drain demonstrating two interlocking filter housing sections.

FIG. 7 is an exploded perspective view of the undergravel filter and drain of FIG. 6 showing the two interlocking sections attached to one another.

### DESCRIPTION

### Definitions

As used herein, the following terms and variations thereof have the meanings given below, unless a different meaning is clearly intended by the context in which such term is used.

“Aquarium” refers to a container, such as a tank or bowl, which is capable of containing water and which can be used to house fish and other aquatic animal and/or plant life.

“Mechanical filtration” refers to the removal of solid waste, such as particles of sludge, uneaten food, and dust from aquarium water as it passes through a filter, in the manner of a sieve or strainer.

“Chemical filtration” refers to the removal of dissolved wastes and odors from aquarium water as a result of contact with a cleaning material such as activated carbon, binding or chemically reacting such unwanted materials.

“Biological filtration” refers to the removal of waste materials, in particular chemicals, harmful to aquatic life by biological means. Such materials are generally produced by fish waste and uneaten food in the water, and biological filtration generally involves transforming such materials into a form which is not harmful to aquatic life.

“Biomedia” refers to a substrate, preferably having a high surface-area-to-volume ratio, which bacteria can colonize and grow upon.

“Porous” describes an article which includes holes or tunnels that allow the passage of liquid or gas from one opening in a surface of the article to another.

“Undergravel filter” refers to an aquarium filter which is positioned on or adjacent to the bottom surface or floor of an aquarium. Undergravel filters typically have gravel placed on top of them, but this is optional for the present undergravel filters.

As used herein, the term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

### Biological Filtration System

The present undergravel filter provides a biomedia-filled compartment inside of an aquarium which promotes the growth of beneficial bacteria capable of removing waste products such as ammonia from aquarium water. The majority of ammonia in an aquarium is formed from waste products generated by the living creatures and unconsumed food in the aquarium. Biomedia, preferably by being porous in structure such as a bioring or bioball, provide a relatively high surface area on which beneficial bacteria can colonize and grow in quantity. In order to carry out the biological transformation of ammonia into nitrate in a nitrogen cycle, by bringing a food source and air/oxygen to the beneficial bacteria, a flow of water through the biomedia is necessary. However, such water flow also carries debris into the biomedia.

When excessive debris accumulates in the biomedia, in particular within the pores of porous biomedia, it tends to clog the biomedia, thereby reducing water flow through the biomedia and also reducing the ability of the beneficial bacteria to reduce ammonia levels in the aquarium water. Because of the inevitable buildup of debris in porous biomedia, such biomedia needs to be cleaned or replaced periodically. Because of this troublesome and unpractical cleaning process required to maintain the nitrite transformation function of biomedia currently biomedia has only been employed in filters located outside of aquariums, where it can be easily accessed, and not within undergravel filters. Cleaning or replacing biomedia if it is included within an undergravel filter would impose a great inconvenience and require much time and work, since fish, decorations, gravel, and the undergravel filter itself would all needed to be removed from the aquarium in order to get to the biomedia inside the undergravel filter, and would then need to be returned back after the cleaning process. Furthermore, when biomedia is washed under untreated tap water or when new biomedia replaces used biomedia, most, if not all, beneficial bacteria are eliminated by the chlorine and other chemicals in tap water during the process. The problem of using biomedia in an undergravel filter is solved through the use of an undergravel filter of the present design together with a drain below the filter in the aquarium.

### Drainage System

Fish waste deposits, unfinished food, and other debris tend to sink in an aquarium and will pile up at the bottom of the tank if it is not picked up and collected by external or submerged canister filters. As such unwanted waste accumulates it reduces the viewing pleasure of an aquarium, degrades the clarity and quality of the aquarium water, and poses the threat of producing harmful and toxic chemicals such as ammonia.

The present undergravel filter and drainage system resolves this waste build-up problem by providing a mechanism for not only cleaning the waste accumulated at the bottom of an aquarium but also at the same time clearing clogged biomedia, namely by directing a flow of water in the aquarium through a filter comprising a biomedia-filled compartment when the aquarium is drained. Since the aquarium water is already conditioned and does not contain chlorine at levels present in tap water, it will not harm beneficial bacteria present in the biomedia.

In order to clean such biomedia, the present filter includes openings in the compartment that retains the biomedia. The openings provide a flow path for water from the aquarium passing through the compartment toward a drain leading to the outside of the aquarium. When the drain valve is opened, downward water pressure created by gravitational forces causes the aquarium water to flow through the present undergravel filter and into the drain. Such flow of water through the compartment containing the biomedia functions to clean the biomedia by removing clogging debris while at the same time preserving the beneficial bacteria associated with the biomedia.

### Filtration System

The combination of a submerged canister power filter and the present undergravel filter can provide a complete and effective cleaning system for an aquarium, providing mechanical, chemical, and biological filtration. Preferably, one of the canister segments of the submerged filter includes media to mechanically filter and trap solid and floating debris, such as through the use of a synthetic fiber media. Another segment of the canister can preferably include a chemical filtration media, such as activated carbon, to remove dissolved wastes and odors. As described herein, the present undergravel filter provides biological filtration through the use of beneficial bacteria to neutralize toxic ammonia in the water.

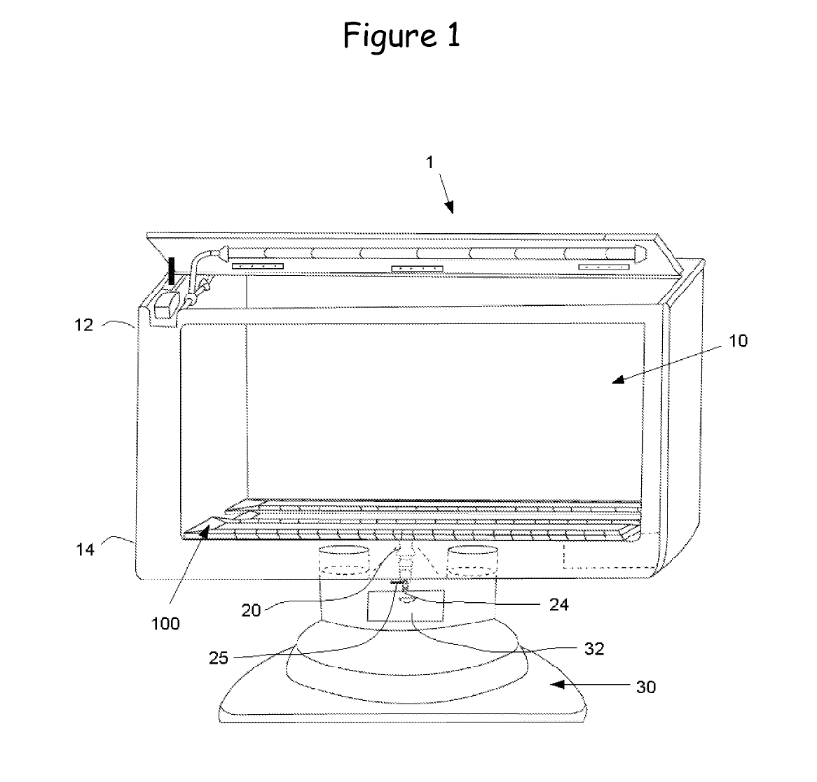

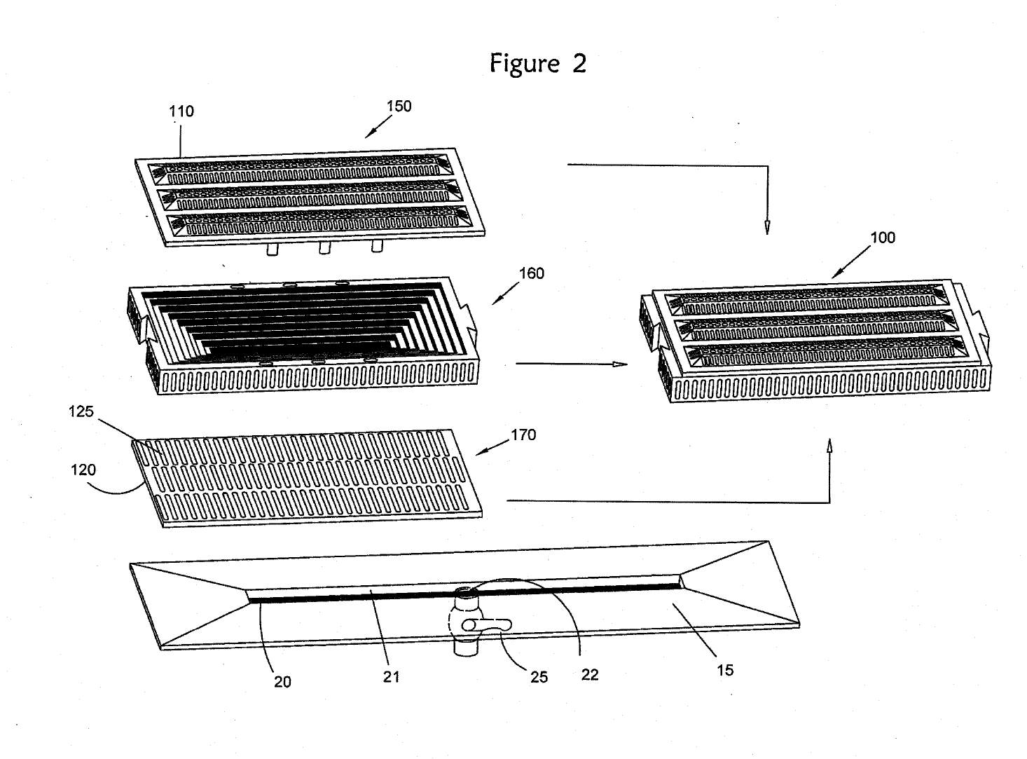

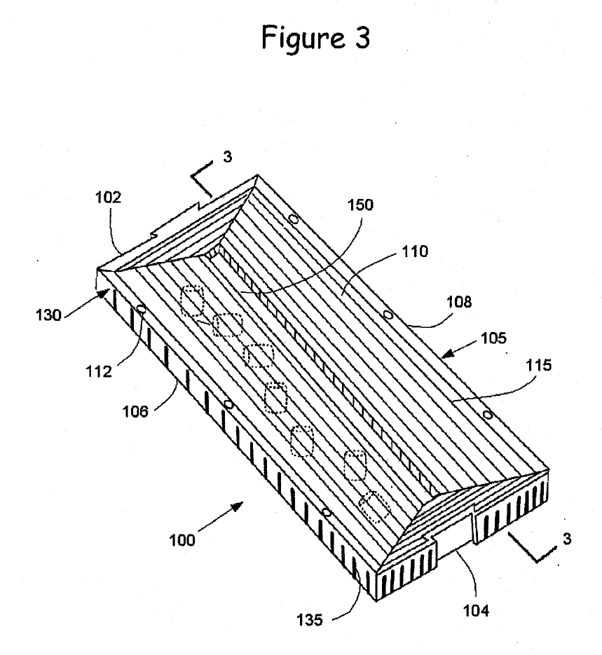

As shown in FIG. 1, the present filtration system 1 comprises an aquarium 10 having an upper end 12 and a lower end 14. At a lower extent of the aquarium 10 is a bottom surface 15 (FIG. 2) which includes a drain 20. The drain 20 is preferably located at the lowest point on the bottom surface 15 of the aquarium 10, in order to facilitate the drainage of water from the aquarium 10 through a drain opening 22 of the drain 20. The drain 20 can be closed in any of a number of ways known to the art in order to retain water in the aquarium 10. Preferably, a valve 25 is provided in the drain in order to reversibly open the drain 20 and thereby remove water from the aquarium 10 through drain 20.

In the embodiment shown in FIG. 1, the aquarium 10 is mounted on a base 30, and the drain 20 comprises a conduit having a drain exit 24 which is accessible from a latched door 32 in the base 30. Alternatively, the aquarium can be mounted onto a wall, and the drain 20 can be directly accessed underneath the aquarium 10. Other ways of mounting and/or supporting an aquarium known to those of skill in the art can also be used together with the present filtration system.

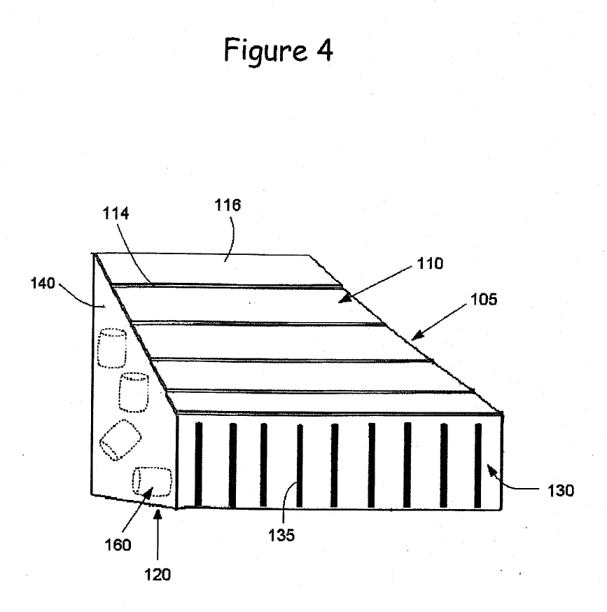

In order to provide the flow of water through the present undergravel filter 100 and circulate waste/nutrients and oxygen to the beneficial bacteria contained therein, the present filtration system 1 further preferably comprises a power water pump 200. In the embodiment of FIG. 4, the pump 200 draws water through the housing 105 of the undergravel filter 100. In the manner of conventional undergravel filters, air can be pumped into the aquarium 10 through an external air pump in order to provide upward lifting current and draw circulating water flow through the present undergravel filter 100.

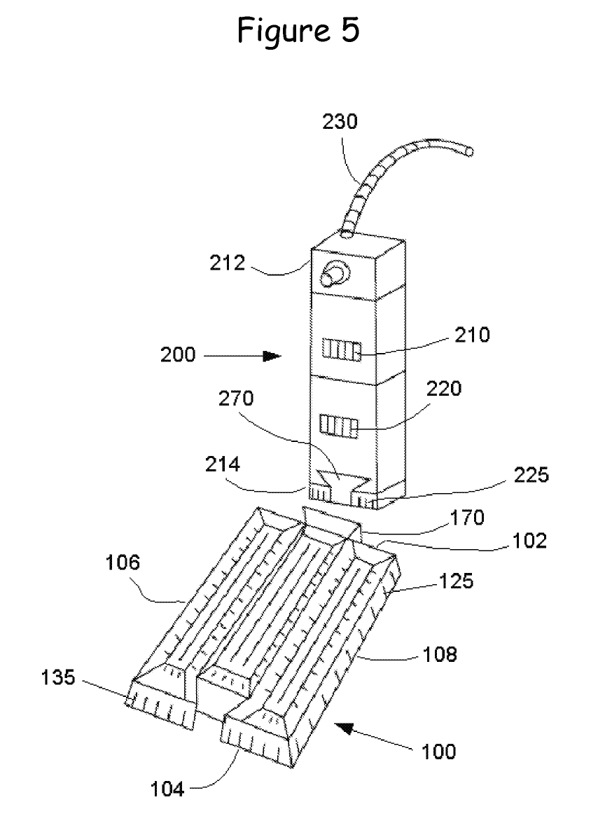

In the embodiment of FIG. 5, pump 200 is mechanically connected to the undergravel filter 100 via a male-female connection, in which the protrusion 170 in the filter housing 105 is sized and shaped to connect to a recess 270 at a lower end 214 of the pump. Other connections known to the art can also be used. The pump 200 preferably includes openings 225 in the lower end 214 which communicate directly with side wall openings 135 in the proximal end 102 (FIG. 4) of the housing 105, and indirectly with side wall openings 135 in the side walls 130 at the distal end 104, medial side 106 and lateral side 108 of the filter housing 105, as well as with upper housing openings 115. In this way, water which is drawn from the openings 115 and 135 of the filter housing 105 flows through the openings 225 in the lower end 214 of the pump 200 and then into the pump canister compartments and out through power pump nozzles. This water circulation generates a flow of water through the interior compartment 140 of the filter housing 105 and through the biomedia 160. Water is also drawn into the pump 200 through openings 210 and/or 220, and power is provided by electrical conduit 230.

In addition to foregoing components of the present filtration system 1, the aquarium 10 can also comprise other aquarium shapes and styles and can be equipped with other components known to the art, such as a heater, lighting unit, and cover. In one embodiment, additional filters, such as a chemical filter, can also be used together with the present filtration system.

### Filter Components

The present undergravel filter 100 comprises a filter housing 105 having an interior compartment 140 for retaining biomedia 160. The housing 105 includes an upper surface 110, a lower surface 120, and side walls 130, as well as openings (115, 125, and 135) which communicate between the exterior of the housing 105 and the interior compartment 140. In particular, one or more upper housing openings 115 in the upper surface 110 and/or one or more side wall openings 135 in the side walls 130 of the filter housing 105 allow water to flow into and through the compartment 140. When the drain valve 25 is opened in order to allow water from the aquarium 10 to drain out, water in the compartment 140 is able to flow into the drain 20 through one or more lower housing openings 125, as shown in FIG. 2.

In the embodiment shown in FIG. 2, the housing 105 can be formed from three components, namely a cover plate 150, a debris collecting tray 160, and a lower plate 170. The cover plate 150 is a lid that fits on top of the debris collecting tray 160 and includes the upper surface 110 of the filter housing 105. The cover plate 150 functions to keep larger objects such as gravel, plants, and fish from entering the interior compartment 140 of the filter housing 105. The cover plate 150 preferably includes upper housing openings 115, which in the illustrated embodiments are formed as thin, laterally or medially extending apertures in the upper surface 110 of the filter housing 105. Other shapes and sizes of openings in the cover plate 150 can also be used.

The cover plate 150 and debris collecting tray 160 can be attached together, for example, with connecting pins 112 that are either formed with or attached to the cover plate 150, and which are then inserted into holes in the debris collecting tray 160. The debris collecting tray 160 and lower plate 170 can likewise be attached in this way. Alternatively, the cover plate 150, debris collecting tray 160, and lower plate 170 can be secured in other ways known to the art. In order to be able to replace biomedia 160 in the interior compartment 140 which contains the biomedia 160, the cover plate 150 and debris collecting tray 160 should be reversibly secured, i.e. attached in a manner that can be reversed without damaging the undergravel filter 100. The debris collecting tray 160 and lower plate 170 can however be permanently secured together if desired, such as through the use of an adhesive or other chemical bond, or such components can be integrally molded. Additional holes or attachment means, such as clamps, can be provided in the upper surface 110 in order to attach plants or decorations to the upper surface 110 of the cover plate 150.

The debris collecting tray 160 provides an area for debris which is drawn through from the upper filter case to collect. The debris collecting tray 160 and cover plate 150 together enclose and/or form the interior compartment 140 for containing biomedia 160.

The lower plate 170 comprises a lower surface 120 which extends over the drain opening 22 in the bottom surface 15 of the aquarium 10. This lower surface comprises one or more lower housing openings 125, in order to allow water flowing through the compartment 140 to exit downwardly through such lower housing openings 125. In a preferred embodiment, the drain 20 comprises a collector channel 21 along a longitudinal axis of the bottom of the aquarium, and the lower house openings 125 are distributed along such longitudinal axis, in order to channel a flow of water through the present undergravel filter 100 and into the collector channel 21 when the drain valve 25 is opened. Preferably, collector channel 21 extends along more than half the longitudinal extent of the aquarium, and the undergravel filter 100 likewise extends across a substantial portion of the bottom surface of the aquarium, preferably covering at least 50% of the surface area of the bottom surface of the aquarium, and more preferably at least 70%-80% of the surface area.

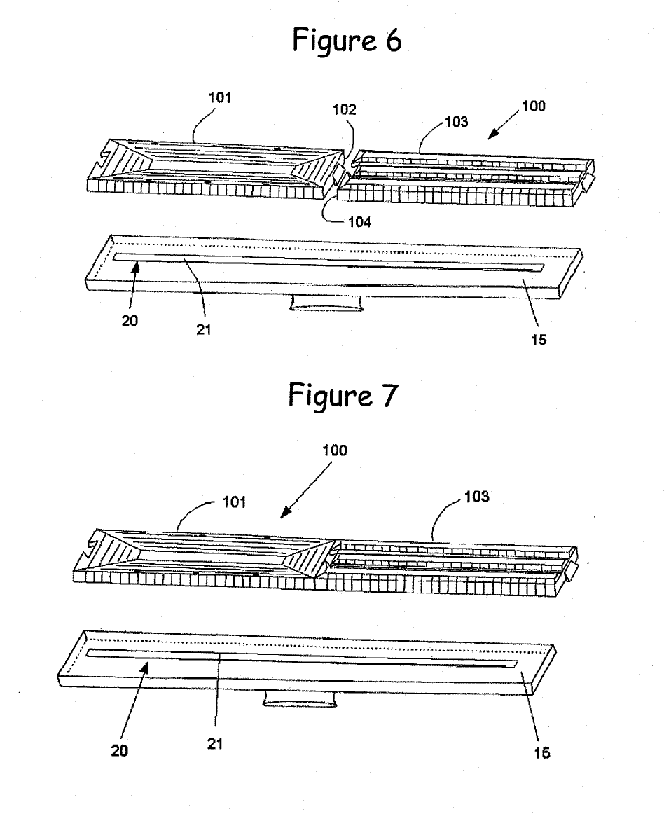

The filter housing 105 can be formed with mated connectors, in order to be able to join different filter housing units in a modular fashion, as shown in FIGS. 6 and 7. In this way, the filter housing 105 can be adapted for use with aquariums of different sizes. For example, in an aquarium having a bottom surface which is larger than at least two filter housings 105, a first filter housing unit 101 and a second filter housing unit 103, shown separated in FIG. 6, can be joined to form a unitary undergravel filter 100 as shown in FIG. 7. In this embodiment, the side wall openings 135 in the proximal end 102 of one filter housing unit will be placed in communication with side wall openings 135 in the distal end 104 of the adjoining filter housing unit, so that water can flow from one unit to the other when connected.

### Biomedia

The biomedia used in the present system is a solid substrate that does not leach substances harmful to aquatic life into the water and that provides a scaffold on which bacteria can grow. Biomedia support beneficial bacteria colonies that break down ammonia and other waste products generated in an aquarium to a less form that's less toxic to aquatic life.

Pieces of biomedia material can be shaped in any of a number of forms, including conical, cylindrical, pyramidal, elongated, cubical, tear dropped, or any other shape allowing a flow of water over the surface area of the material. In one embodiment, biomedia comprises a plurality of solid pieces of material, such as plastic “bio balls” sold for use as biomedia. A sufficient number of such bio balls of small diameter can provide a large surface area for bacterial growth. Preferably, such solid biomedia is formed with crevices and/or projections in order to increase the surface area on such pieces of biomedia on which bacteria can grow. An example of such biomedia is lava rock, which generally includes air holes that increase the surface area of the rock.

A preferred biomedia is made from a porous material, such as biomedia formed from porous ceramic or clay. The use of porous material greatly increases the surface area available to be colonized by beneficial bacteria, which thereby increases the ability of such biomedia to remove waste from aquarium water. Porous biomedia materials preferably provide an effective surface area of between 20 and 200 square meters/liter of biomedia material, for example between about 100 and 150 square meters/liter of material. Such materials also preferably exhibit at least 30% porosity, more preferably at least 50% porosity, and more preferably over 60% porosity.

The biomedia used in the present system preferably have a high surface-area-to-volume (sa/vol) ratio. In general, sa/vol ratios of greater than 10 m²/m³ are desirable. Preferably biomedia used in the present system have an sa/vol ratio of at least 50 m²/m³, more preferably of at least 100 m²/m³, even more preferably of at least 500 m²/m³, and most preferably at least 800 m²/m³.

One type of biomedia that can be used in the present undergravel filter is a ceramic ring, also known as bio rings, which are typically cylindrical and highly porous. Another example of a biomedia material is sold as F1320 Aquaclay Biological Filter Media, available from Keeton Industries, Wellington, Colo. 80549. Typically, a plurality of such porous materials are contained within the present undergravel filter. Alternatively, however, a single block of porous material of sufficient size can also be used in the present filter.

Water is usually flowed through the biological media in the present filter in order to bring the nutrients and oxygen required by the bacteria on the surfaces of the biomedia. The flow rate in the present undergravel filter is preferably sufficient to cycle water in the aquarium through the biological media 4-5 times per hour.

### Method of Operation

When it is desired to clean the biomedia of the undergravel filter and/or remove water from the aquarium 10, the valve 25 or other means of opening the drain 20 is opened. Gravitational force then causes water from the aquarium 10 to flow through the upper housing openings 115 of the filter housing 105 and/or through the side wall openings 135 and into the compartment 140. Such water then flows through the lower housing openings 125 of the filter housing and into the drain 20 through the drain opening 22. At least some of the water flowing through the compartment 140 will also flow through the biomedia 160, thereby removing debris and cleaning the biomedia 160 so that it can more effectively remove waste from the aquarium 10.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference in their entirety.

What is claimed is:

1. A drainage and filtration system for an aquarium, comprising:
(1) an aquarium having a drain, the drain comprising a drain opening in a bottom surface of the aquarium, the drain comprising a valve for reversibly opening the drain to allow a flow of water therethrough; and
(2) an undergravel filter positioned over the drain opening, comprising:
(a) a first housing, wherein the first housing comprises:
a lower surface comprising one or more lower housing openings;
an upper surface opposite the lower surface;
one or more walls extending between the lower surface and the upper surface of the first housing;
one or more upper housing openings in the upper surface of the first housing, the one or more walls, or both; and
a compartment within the first housing, wherein the compartment is in communication with an exterior of the first housing through the upper housing openings, and wherein the compartment is in communication with the drain opening through the lower housing openings, thereby allowing a flow of water from the exterior of the first housing through the compartment to the drain when the drain opening is open; and
(b) one or more pieces of biomedia material in the compartment.

2. The drainage and filtration system of claim 1, wherein the first housing comprises a debris collecting tray having an upper surface and a lower surface, a cover plate covering the upper surface of the debris collecting tray and comprising the upper surface of the first housing, and a lower plate below the debris collecting tray comprising the lower surface of the first housing.

3. The drainage and filtration system of claim 1, wherein the cover plate is reversibly secured to the debris collecting tray in order to allow biomedia to be accessed in the debris collecting tray.

4. The drainage and filtration system of claim 1, further comprising a water pump connected to a side wall of the first housing of the undergravel filter, wherein the water pump comprises openings in a lower end in direct communication with upper housing openings in the side wall of the first housing.

5. The drainage and filtration system of claim 1, wherein the drain comprises a collector channel extending along the longitudinal extent of the aquarium between the drain opening and a lateral side of the aquarium.

6. The drainage and filtration system of claim 1, wherein the first housing comprises a proximal end and a distal end, the distal end comprising a first half of a mated connector, further comprising a second housing comprising a proximal end, a distal end, and a second half of a mated connector at the proximal end, wherein the first half and the second half of the mated connector cooperate to attach the first housing to the second housing.

7. The drainage and filtration system of claim 1, wherein the aquarium comprises a bottom surface, and wherein the undergravel filter covers more than 50% of the bottom surface of the aquarium.

8. The drainage and filtration system of claim 1, wherein the undergravel filter covers more than 80% of the bottom surface of the aquarium.

9. The drainage and filtration system of claim 1, wherein the biomedia material is porous.

10. The drainage and filtration system of claim 9, wherein the biomedia has a surface-area-to-volume ratio of at least 100 m²/m³.

11. The drainage and filtration system of claim 9, wherein the biomedia has a surface-area-to-volume ratio of at least 500 m²/m³.

12. The drainage and filtration system of claim 1, wherein the biomedia material has an effective surface area of between 20 and 200 square meters/liter of the biomedia material.

13. A method of cleaning biomedia in an aquarium, comprising:
(a) providing the drainage and filtration system of claim 1;
(b) opening the drain opening in order to provide a flow of water through the compartment of the undergravel filter.
